(19) United States
(12) Patent Application Publication
(10) Pub. No.: US 2016/0055934 A1
(43) Pub. Date: Feb. 25, 2016

(54) LUBRICATING-OIL BASE OIL, METHOD FOR PRODUCING SAME, AND ELECTRICALLY INSULATING OIL

(71) Applicant: JX NIPPON OIL & ENERGY CORPORATION, Tokyo (JP)

(72) Inventor: Kazuo TAGAWA, Tokyo (JP)

(73) Assignee: JX NIPPON OIL & ENERGY CORPORATION, Tokyo (JP)

(21) Appl. No.: 14/779,127

(22) PCT Filed: Mar. 26, 2014
(86) PCT No.: PCT/JP2014/058633

§ 371 Date: Sep. 22, 2015

(30) Foreign Application Priority Data
Mar. 29, 2013 (JP) 2013-072237

(51) Int. Cl. H01B 3/22; C10G 65/12; C10M 101/02

(52) U.S. Cl. CPC H01B 3/22; C10M 101/025; C10G 65/12

(57) ABSTRACT

Disclosed is a method for producing a lubricating base oil. The method comprises subjecting a synthetic wax obtained by a gas-to-liquid process, or a lubricating-oil fraction separated from the synthetic wax, to hydrocracking, thereby obtaining a hydrocracked oil having a normal paraffin content of 30% or greater and 50% or less; and subjecting the hydrocracked oil to hydroisomerization dewaxing in the presence of a hydroisomerization catalyst, wherein the lubricating base oil has a volume resistivity at 80° C. of 1 TΩ·m or greater, and a volume resistivity at 25° C. relative to the volume resistivity at 80° C. that satisfies conditions represented by the following formula (1):

B(25° C.)/A(80° C.)≧1.5

wherein in formula (1), A (80° C.) indicates the volume resistivity at 80° C. of the lubricating base oil, and B (25° C.) indicates the volume resistivity at 25° C. of the lubricating base oil.

### TECHNICAL FIELD

The present invention relates to a lubricating base oil, a method for producing the same, and an electrically insulating oil.

### BACKGROUND ART

In conventional oil-filled electrical devices, such as oil-filled transformers and oil-filled reactors, solid insulating materials and electrically insulating oils are used for insulation between conductive members. For example, in the case of an oil-filled transformer, insulation between its iron core and coil is achieved by disposing a solid insulating material between the iron core and the coil, and immersing them in an electrically insulating oil (Patent Literature 1).

Known electrically insulating oils are, for example, an oil produced from an isomerized base oil (Patent Literature 2), an oil containing a hydrocarbon compound in which the total number of terminal methyl groups and methylene groups in the main chain is 16 or greater, and the total number of methyl branches and ethyl branches is 1 or less (Patent Literature 3), and the like.

### CITATION LIST

### Patent Literature

Patent Literature 1: JP-A-2001-143933
Patent Literature 2: JP-T-2010-532084
Patent Literature 3: JP-A-2011-148970

### SUMMARY OF INVENTION

### Technical Problem

An object of the present invention is to provide a lubricating base oil having more excellent electrical insulating properties than lubricating base oils contained in conventional electrically insulating oils, a method for producing the lubricating base oil of the present invention, and an electrically insulating oil using the lubricating base oil of the present invention.

### Solution to Problem

In order to solve the above problem, the present invention provides a method for producing a lubricating base oil according to the following [1] and [2], a lubricating base oil according to the following [3] and [4], and an electrically insulating oil according to the following [5].

[1]A method for producing a lubricating base oil, the method comprising:

a first step of subjecting a synthetic wax obtained by a gas-to-liquid process, or a lubricating-oil fraction separated from the synthetic wax, to hydrocracking, thereby obtaining a hydrocracked oil having a normal paraffin content of 30% or greater and 50% or less; and

a second step of subjecting the hydrocracked oil to hydroisomerization dewaxing in the presence of a hydroisomerization catalyst, thereby obtaining a lubricating base oil;

wherein the lubricating base oil has a volume resistivity at 80° C. of 1 TΩ·m or greater, and

a volume resistivity at 25° C. relative to the volume resistivity at 80° C. that satisfies conditions represented by the following formula (1):

B(25° C.)/A(80° C.)≧1.5 (1)

wherein in formula (1), A (80° C.) indicates the volume resistivity at 80° C. of the lubricating base oil, and B (25° C.) indicates the volume resistivity at 25° C. of the lubricating base oil.
[2] The method for producing a lubricating base oil according to [1], wherein the hydroisomerization catalyst comprises:

at least one crystalline solid acidic substance selected from the group consisting of ZSM-22 type zeolite, ZSM-23 type zeolite, SSZ32, and ZSM-48 type zeolite; and

platinum and/or palladium as an active metal.

[3]A lubricating base oil having a normal paraffin content of 30% or greater and 50% or less, wherein the lubricating base oil has a volume resistivity at 80° C. of 1 TΩ·m or greater, and a volume resistivity at 25° C. relative to the volume resistivity at 80° C. that satisfies conditions represented by the following formula (1):

B(25° C.)/A(80° C.)≧1.5 (1)

wherein in formula (1), A (80° C.) indicates the volume resistivity at 80° C. of the lubricating base oil, and B (25° C.) indicates the volume resistivity at 25° C. of the lubricating base oil.
[4] The lubricating base oil according to [3], wherein the lubricating base oil is obtained by the production method according to [1] or [2].
[5] An electrically insulating oil comprising the lubricating base oil according to [3] or [4].

### Advantageous Effects of Invention

The present invention can provide a lubricating base oil having more excellent electrical insulating properties than lubricating base oils contained in conventional electrically insulating oils, a method for producing the lubricating base oil of the present invention, and an electrically insulating oil using the lubricating base oil of the present invention.

### DESCRIPTION OF EMBODIMENTS

A preferred embodiment of the present invention is described in detail below.

The method for producing a lubricating base oil according to the embodiment of the present invention comprises:

a first step of subjecting a synthetic wax obtained by a gas-to-liquid process, or a lubricating-oil fraction separated from the synthetic wax, to hydrocracking, thereby obtaining a hydrocracked oil having a normal paraffin content of 30% or greater and 50% or less; and

a second step of subjecting the hydrocracked oil to hydroisomerization dewaxing in the presence of a hydroisomerization catalyst, thereby obtaining a lubricating base oil;

wherein the lubricating base oil has a volume resistivity at 80° C. of 1 TΩ·m or greater; and

a volume resistivity at 25° C. relative to the volume resistivity at 80° C. that satisfies conditions represented by the following formula (1).

Further, the lubricating base oil according to the embodiment of the present invention is obtained by the above production method, wherein the lubricating base oil has a volume resistivity at 80° C. of 1 TΩ·m or greater, and the volume resistivity at 25° C. relative to the volume resistivity at 80° C. satisfies conditions represented by the following formula (1):

B(25° C.)/A(80° C.)≧1.5 (1)

wherein in formula (1), A (80° C.) indicates the volume resistivity at 80° C. of the lubricating base oil, and B (25° C.) indicates the volume resistivity at 25° C. of the lubricating base oil.

The volume resistivity at 80° C. (A (80° C.)) of the lubricating base oil according to the present embodiment is 100 TΩ·m or greater, preferably 50 TΩ·m or greater, more preferably 70 TΩ·m or greater, and even more preferably 100 TΩ·m or greater. Further, the volume resistivity at 80° C. (A (80° C.)) is preferably 1,000 TΩ·m or less, or 500 TΩ·m or less.

Moreover, the ratio (B (25° C.)/A (80° C.)) of the volume resistivity at 25° C. (B (25° C.)) of the lubricating base oil to A (80° C.) is 1.5 or greater, and preferably 2 or greater. Further, B (25° C.)/A (80° C.) is 5 or less, and more preferably 4 or less.

B (25° C.) is not particularly limited, as long as B (25° C.)/A (80° C.) satisfies the above conditions; however, B (25° C.) is preferably 70 TΩ·m or greater, more preferably 100 TΩ·m or greater, and even more preferably 200 TΩ·m or greater. Further, B (25° C.) is preferably 5,000 TΩ·m or less, more preferably 1,000 TΩ·m or less, and even more preferably 500 TΩ·m or less.

Note that the volume resistivity as mentioned in the present invention is a value measured according to JIS C 2320-1999.

Moreover, the surface tension at 25° C. of the lubricating base oil according to the present embodiment is preferably 10 mN/m or greater, and preferably 20 mN/m or greater. Further, the surface tension at 25° C. is preferably 60 mN/m or less, more preferably 50 mN/m or less, even more preferably 40 mN/m or less, and particularly preferably 26 mN/m or less. When the surface tension is less than the above lower limit, the organic materials in the equipment to which the electrically insulating oil is applied may be adversely affected. In contrast, when the surface tension is more than the above upper limit, the solubility of insoluble components generated in the electrically insulating oil tends to be reduced. Note that the surface tension as mentioned in the present invention is a value measured according to JIS K 2241.

Moreover, the dielectric breakdown voltage of the lubricating base oil according to the present embodiment is preferably is 30 kV or greater, more preferably 50 kV or greater, and even more preferably 60 kV or greater, in terms of preventing explosion due to electric leakage. Note that the dielectric breakdown voltage as mentioned in the present invention is a value measured according to JIS C2101.

Moreover, the kinematic viscosity at 40° C. of the lubricating base oil according to the present embodiment is preferably 7 to 60 mm²/s, more preferably 8 to 50 mm²/s, and even more preferably 8.5 to 36 mm²/s.

The kinematic viscosity at 100° C. of the lubricating base oil according to the present embodiment is preferably 2 to 15 mm²/s, more preferably 2.2 to 10 mm²/s, and even more preferably 2.5 to 8.0 mm²/s.

Moreover, the viscosity index of the lubricating base oil according to the present embodiment is preferably 100 or greater, more preferably 110 or greater, and even more preferably 120 or greater. An increase in viscosity index leads to a reduction in the changes in volume resistivity with temperature. In addition, cold flow property can be ensured.

Note that the kinematic viscosity and viscosity index as mentioned in the present invention are, respectively, the kinematic viscosity and viscosity index measured according to JIS K 2283-1993.

Moreover, the CCS viscosity at −35° C. of the lubricating base oil according to the present embodiment is preferably 1,300 mPa·s or less, and more preferably 1,000 mPa·s or less. When the CCS viscosity at −30° C. or −35° C. is more than the above upper limit, the cold flow property of the entire lubricating oil using the lubricating base oil tends to decrease.

Furthermore, the CCS viscosity at −35° C. of SAE 10 is preferably 2,000 mPa·s or less, and more preferably 1,750 mPa·s or less. When the CCS viscosity at −30° C. or −35° C. is more than the above upper limit, the cold flow property of the entire lubricating oil using the lubricating base oil tends to decrease.

In addition, the CCS viscosity at −35° C. of SAE 20 is preferably 1,500 mPa·s or less, and more preferably 1,300 mPa·s or less. When the CCS viscosity at −30° C. or −35° C. is more than the above upper limit, the cold flow property of the entire lubricating oil using the lubricating base oil tends to decrease.

Note that the CCS viscosity at −30° C. or −35° C. as mentioned in the present invention is the viscosity measured according to JIS K 2010-1993.

Moreover, the sulfur content of the lubricating base oil according to the present embodiment is preferably 10 mass ppm or less, more preferably 5 mass ppm or less, even more preferably 3 mass ppm or less, and particularly preferably 1 mass ppm or less, in terms of thermal oxidation stability and a reduction in the sulfur content. In general, the sulfur content of a lubricating base oil depends on the sulfur content of the raw material of the lubricating base oil. When a raw material that does not substantially contain sulfur (e.g., a synthetic wax component obtained by the Fischer Tropsch (FT) reaction, or the like) is used, a lubricating base oil that does not substantially contain sulfur can be obtained. In contrast, when a raw material containing sulfur (e.g., slack wax obtained in the refining process of the lubricating base oil, or micro wax obtained in the waxing process) is used, the sulfur content of the obtained lubricating base oil is generally 100 mass ppm or greater. Note that the sulfur content as mentioned in the present invention is the sulfur content measured according to JIS K 2541-1996.

Moreover, the FT reaction is a reaction to synthesize a hydrocarbon compound from hydrogen and carbon monoxide, and the reaction product does not substantially contain nitrogen components. Therefore, when the FT reaction product is used as the raw material of the lubricating base oil, sulfur poisoning can be suppressed during hydrocracking and hydroisomerization dewaxing, as described later.

Moreover, the pour point of the lubricating base oil according to the present embodiment is preferably −5° C. or less, more preferably −10° C. or less, and even more preferably-12.5° C. or less. When the pour point is more than the above upper limit, the cold flow property of the entire lubricating oil using the lubricating base oil tends to decrease. Further, the pour point of the lubricating base oil according to the present embodiment is preferably −20° C. or greater, more preferably −17.5° C. or greater, and even more preferably −15° C. or greater. When the pour point is less than −20° C., the sealing properties tend to be insufficient. Note that the pour point as mentioned in the present invention is the pour point measured according to JIS K 2269-1987.

Moreover, the density at 15° C. (ρ₁₅) of the lubricating base oil according to the present embodiment is preferably 0.85 g/cm³ or less, and more preferably 0.83 g/cm³ or less. Note that the density at 15° C. as mentioned in the present invention is the density measured at 15° C. according to JIS K 2249-1995.

Next, the production method of the lubricating base oil according to the present embodiment is described in detail.

The raw material to be subjected to the first step is a synthetic wax obtained by a gas-to-liquid process, or a lubricating oil fraction separated from the synthetic wax. These raw materials generally contain a hydrocarbon compound having 18 to 60 carbon atoms.

Examples of the synthetic wax include Fischer Tropsch wax, GTL wax, and the like. Such synthetic waxes or lubricating oil fractions generally do not contain nitrogen components; therefore, sulfur poisoning can be suppressed during hydrocracking and hydroisomerization dewaxing.

Moreover, when a lubricating oil fraction is used as the raw material, the means for separating the lubricating oil fraction from a synthetic wax is not particularly limited; for example, atmospheric distillation or vacuum distillation can be used.

The form of the reactor used in the hydrocracking treatment is not particularly limited, and a fixed-bed flow reactor filled with a hydrocracking catalyst is preferably used. A single reactor may be used, or a plurality of reactors arranged in series or in parallel may be used. Further, the number of catalyst beds in the reactor may be singular or plural.

As the hydrocracking catalyst, a known hydrocracking catalyst is used. It is preferable to use a catalyst in which a metal belonging to Groups 8 to 10 of the periodic table of elements having hydrogenation activity is supported on an inorganic support having solid acidity (hereinafter referred to as the “hydrocracking catalyst A”). In particular, when the hydrocarbon oil is FT synthetic oil, there is no fear of catalyst poisoning due to sulfur components; therefore, hydrocracking catalyst A is suitably used.

Preferred examples of the inorganic support having solid acidity that constitutes the hydrocracking catalyst A include supports comprising a zeolite, such as ultra-stable Y (USY) zeolite, Y zeolite, mordenite, or β-zeolite; and one or greater inorganic compounds selected from amorphous composite metal oxides having heat resistance, such as silica alumina, silica zirconia, and alumina boria. Furthermore, the support is more preferably a composition comprising USY zeolite and one or greater amorphous composite metal oxides selected from silica alumina, alumina boria, and silica zirconia; and even more preferably a composition comprising USY zeolite, and alumina boria and/or silica alumina.

The USY zeolite is obtained by ultra-stabilizing Y zeolite by hydrothermal treatment and/or acid treatment, and has a micropore structure called micropores with a pore diameter of 2 nm or less, which is inherent in the Y zeolite, as well as new pores with a pore diameter in the range of 2 to 10 nm. The average particle diameter of the USY zeolite is not particularly limited, but is preferably 1.0 μm or less, and more preferably 0.5 m or less. Further, the molar ratio of silica/alumina (molar ratio of silica to alumina) in the USY zeolite is preferably 10 to 200, more preferably 15 to 100, and even more preferably 20 to 60.

Moreover, the support of the hydrocracking catalyst A preferably contains 0.1 to 80 mass % of crystalline zeolite and 0.1 to 60 mass % of an amorphous composite metal oxide having heat resistance.

The support of the hydrocracking catalyst A can be produced by molding a support composition containing the above inorganic compound having solid acidity and a binder, followed by calcination. The proportion of the inorganic compound having solid acidity is preferably 1 to 70 mass %, and more preferably 2 to 60 mass %, based on the mass of the entire support. Moreover, when the support contains USY zeolite, the proportion of USY zeolite is preferably 0.1 to 10 mass %, and more preferably 0.5 to 5 mass %, based on the mass of the entire support. Furthermore, when the support contains USY zeolite and alumina boria, the blending ratio of USY zeolite to alumina boria (USY zeolite/alumina boria) is preferably 0.03 to 1, by mass ratio. When the support contains USY zeolite and silica alumina, the blending ratio of USY zeolite to silica alumina (USY zeolite/silica alumina) is preferably 0.03 to 1, by mass ratio.

Although the binder is not particularly limited, it is preferably alumina, silica, titania, or magnesia; and more preferably alumina. The amount of the binder is preferably 20 to 98 mass %, and more preferably 30 to 96 mass/o, based on the mass of the entire support.

The temperature when calcining the support composition is preferably within the range of 400 to 550° C., more preferably 470 to 530° C., and even more preferably 490 to 530° C. Calcination at such a temperature can impart sufficient solid acidity and mechanical strength to the support.

Specific examples of the metal belonging to Groups 8 to 10 of the periodic table having hydrogenation activity supported on the support include cobalt, nickel, rhodium, palladium, iridium, platinum, and the like. Among these, one or greater metals selected from nickel, palladium, and platinum are preferably used singly or in combination. These metals can be supported on the above support by a standard method, such as impregnation or ion-exchange. Although the amount of the metal supported is not particularly limited, the total metal amount is preferably 0.1 to 3.0 mass/o, based on the mass of the support. Note that the periodic table of elements as mentioned herein is the long period type periodic table of elements based on the rules of the IUPAC (International Union of Pure and Applied Chemistry).

When the hydrocracking catalyst A is used, the conditions for bringing the base oil fraction into contact with the hydrocracking catalyst A in the presence of hydrogen are not particularly limited; however, the following reaction conditions can be selected. That is, the reaction temperature is, for example, 180 to 400° C., preferably 200 to 370° C., more preferably 250 to 350° C., and particularly preferably 280 to 350° C. When the reaction temperature is more than 400° C., cracking into light components proceeds, and the yield of the base oil fraction decreases. In addition, the resulting product is colored and its use as a fuel oil base material tends to be limited. In contrast, when the reaction temperature is less than 180° C., the hydrocracking reaction does not sufficiently proceed, and the yield of the base oil fraction decreases. The hydrogen partial pressure is, for example, 0.5 to 12 MPa, and preferably 1.0 to 5.0 MPa. When the hydrogen partial pressure is less than 0.5 MPa, hydrocracking tends to progress insufficiently. In contrast, when the hydrogen partial pressure is more than 12 MPa, devices are required to have high pressure resistance, and facility costs tend to increase. The liquid-hourly space velocity (LHSV) of the heavy fraction is, for example, 0.1 to 10.0 h⁻¹, and preferably 0.3 to 3.5 h⁻¹. When the LHSV is less than 0.1 h⁻¹, hydrocracking overly proceeds, and productivity tends to be reduced. In contrast, when the LHSV is more than 10.0 h⁻¹, hydrocracking tends to proceed insufficiently. The hydrogen/oil ratio is, for example, 50 to 1,000 NL/L, and preferably 70 to 800 NL/L. When the hydrogen/oil ratio is less than 50 NL/L, hydrocracking tends to proceed insufficiently. In contrast, when the hydrogen/oil ratio is more than 1,000 NL/L, large-scale hydrogen supply systems and the like tend to be required.

The composition of the hydrocracked oil obtained by the first step is determined by the hydrocracking catalyst used and the hydrocracking reaction conditions. Note that the “hydrocracked oil” as mentioned herein refers to all products resulting from hydrocracking, including uncracked heavy fractions, unless otherwise noted.

In the hydrocracked oil obtained after the first step, the content ratio of normal paraffins is 28 mass % or greater, preferably 30 mass % or greater, and more preferably 33 mass % or greater. Further, the content ratio of normal paraffins is 60 mass % or less, preferably 55 mass % or less, and more preferably 50 mass % or less. When the content ratio of normal paraffins is less than the above lower limit, there are concerns over the insufficient increase in viscosity index. In contrast, when the content ratio of normal paraffins is more than the above upper limit, isomerization cannot be sufficiently performed, and there are concerns over the increase in the pour point of the product.

When the hydrocracking reaction conditions are unnecessarily severe, the uncracked heavy fraction content of the hydrocracked oil decreases; however, light components having a boiling point of 340° C. or less increase, and the yield of the preferred base oil fraction (340 to 520° C. fraction) decreases. In contrast, when the hydrocracking reaction conditions are unnecessarily mild, uncracked heavy fractions increase, and the yield of the base oil fraction decreases. When the ratio of the mass M2 of cracked products having a boiling point of 25 to 520° C. to the mass M1 of all of the cracked products having a boiling point of 25° C. or greater (M2/M1) is regarded as “the cracking ratio,” it is preferable to select reaction conditions so that the cracking ratio M2/M1 is generally 5 to 70%, preferably 10 to 60%, and more preferably 20 to 50%.

Next, in the second-step, the hydrocracked oil is brought into contact with a hydroisomerization catalyst in the presence of hydrogen (molecular hydrogen) to thereby obtain a lubricating base oil in which the volume resistivity at 80° C. is 1 TO*m or greater, and the volume resistivity at 25° C. relative to the volume resistivity at 80° C. satisfies conditions represented by the following formula (1).

As the reactor for hydroisomerization dewaxing, a known fixed-bed reactor can be used. More specifically, hydroisomerization dewaxing can be performed by, for example, placing a hydroisomerization catalyst in a fixed-bed flow reactor, and passing hydrogen (molecular hydrogen) and the hydrocracked oil through the reactor.

Examples of the hydroisomerization catalyst include catalysts generally used in hydroisomerization, i.e., catalysts in which a metal having hydrogenation activity is supported on an inorganic support.

As the metal having hydrogenation activity that constitutes the hydroisomerization catalyst, one or greater metals selected from the group consisting of metals belonging to Groups 6, 8, 9, and 10 of the periodic table of elements can be used. Specific examples of these metals include noble metals, such as platinum, palladium, rhodium, ruthenium, iridium, and osmium; or cobalt, nickel, molybdenum, tungsten, iron, and the like. Preferable among these are platinum, palladium, nickel, cobalt, molybdenum, and tungsten; and more preferable are platinum and palladium. Moreover, it is preferable to use several types of these metals in combination. Preferred combinations in that case include platinum-palladium, cobalt-molybdenum, nickel-molybdenum, nickel-cobalt-molybdenum, nickel-tungsten, and the like.

Examples of the inorganic support that constitutes the hydroisomerization catalyst include metal oxides, such as alumina, silica, titania, zirconia, and boria; or zeolites, and the like. The inorganic support may further contain a binder in order to improve the moldability and mechanical strength of the support. Preferred binders are alumina, silica, magnesia, and the like.

The hydroisomerization catalyst used in the present embodiment is preferably a catalyst comprising at least one crystalline solid acidic substance selected from the group consisting of ZSM-22 type zeolite, ZSM-23 type zeolite, SSZ32, and ZSM-48 type zeolite; and platinum and/or palladium as an active metal.

The above preferable hydroisomerization catalyst is produced by a specific method to thereby impart its characteristics. The following describes the hydroisomerization catalyst of the present embodiment, in accordance with a preferred embodiment of the production of the hydroisomerization catalyst.

The method for producing the hydroisomerization catalyst according to the present embodiment comprises:

a first step of heating a mixture containing a binder and an ion-exchanged zeolite obtained by ion-exchange of an organic template-containing zeolite containing an organic template and having a 10-membered ring one-dimensional pore structure in a solution containing ammonium ions and/or protons, under N₂ atmosphere at a temperature of 250 to 350° C. to thereby obtain a support precursor, and

a second step of calcining a catalyst precursor, obtained by incorporating a platinum salt and/or a palladium salt, into the support precursor in an atmosphere containing molecular oxygen at a temperature of 350 to 400° C. to thereby obtain a hydroisomerization catalyst in which platinum and/or palladium is supported on the zeolite-containing support.

The organic template-containing zeolite used in the present embodiment has a 10-membered ring one-dimensional pore structure, in terms of achieving a high level of both high isomerization activity and suppressed cracking activity in the hydroisomerization reaction of normal paraffins. Examples of the zeolite include AEL, EUO, FER, HEU, MEL, MFI, NES, TON, MTT, WEI, *MRE, SSZ-32, and the like. Note that the three alphabet letters each refer to framework type codes assigned to the structures of classified molecular sieve-type zeolites by the Structure Commission of the International Zeolite Association. Also note that zeolites having the same topology are collectively designated by the same code.

Among the above-mentioned zeolites having a 10-membered ring one-dimensional pore structure, preferred as the organic template-containing zeolite are zeolites having the TON or MTT structure, ZSM-48 zeolite, which is a zeolite having the *MRE structure, and SSZ-32 zeolite, in terms of high isomerization activity and low cracking activity. ZSM-22 zeolite is more preferred among zeolites having the TON structure, and ZSM-23 zeolite is more preferred among zeolites having the MTT structure.

The organic template-containing zeolite is hydrothermally synthesized by a known method using a silica source, an alumina source, and an organic template that is added to construct the above predetermined pore structure.

The organic template is an organic compound having an amino group, an ammonium group, or the like, and is selected according to the structure of the zeolite to be synthesized; however, the organic template is preferably an amine derivative. Specifically, the organic template is more preferably at least one member selected from the group consisting of alkylamines, alkyldiamines, alkyltriamines, alkyltetramines, pyrrolidine, piperazine, aminopiperazine, alkylpentamines, alkylhexamines, and derivatives thereof.

The molar ratio of the silicon element to the aluminum element ([Si]/[Al]; hereinafter referred to as the “Si/Al ratio”) that constitutes the organic template-containing zeolite having a 10-membered ring one-dimensional pore structure is preferably 10 to 400, and more preferably 20 to 350. A Si/Al ratio of less than 10 is not preferable because, although the activity for the conversion of normal paraffins increases, the isomerization selectivity to isoparaffins tends to decrease, and cracking reactions tend to sharply increase as the reaction temperature increases. In contrast, a Si/Al ratio of more than 400 is not preferable because the catalytic activity required for the conversion of normal paraffins is less likely to be obtained.

The organic template-containing zeolite, which has been synthesized and preferably washed and dried, generally has alkali metal cations as counter cations, and incorporates an organic template in its porous structure. The zeolite containing an organic template, which is used in the production of the hydroisomerization catalyst of the present invention, is preferably in such a synthesized state; that is, it is preferable that the zeolite is not subjected to calcination treatment to remove the organic template contained therein.

The above organic template-containing zeolite is subsequently subjected to ion-exchange in a solution containing ammonium ions and/or protons. By the ion-exchange treatment, the counter cations contained in the organic template-containing zeolite are exchanged with ammonium ions and/or protons. At the same time, part of the organic template contained in the organic template-containing zeolite is removed.

The solution used in the ion-exchange treatment is preferably a solution using a solvent containing at least 50 volume % of water, and more preferably an aqueous solution. Examples of compounds for supplying ammonium ions into the solution include various inorganic and organic ammonium salts, such as ammonium chloride, ammonium sulfate, ammonium nitrate, ammonium phosphate, and ammonium acetate. On the other hand, mineral acids, such as hydrochloric acid, sulfuric acid, and nitric acid, are generally used as compounds for supplying protons into the solution. The ion-exchanged zeolite (herein an ammonium-form zeolite) obtained by ion-exchange of the organic template-containing zeolite in the presence of ammonium ions releases ammonia during subsequent calcination, and the counter cations are converted into protons to form Bronsted acid sites. Ammonium ions are preferred as the cationic species used in the ion-exchange. The amount of ammonium ions and/or protons contained in the solution is preferably set to 10 to 1,000 equivalents relative to the total amount of the counter cations and organic template contained in the organic template-containing zeolite.

The ion-exchange treatment may be applied to the organic template-containing zeolite in powder form alone. Alternatively, prior to the ion-exchange treatment, the organic template-containing zeolite may be mixed with an inorganic oxide, which serves as a binder, the mixture may be molded, and the ion-exchange treatment may be applied to the resulting molded product. However, when the molded product is subjected to the ion-exchanged treatment without calcination, problems such as collapsing and powdering of the molded product are more likely to occur; therefore, it is preferable to subject the organic template-containing zeolite in powder form to the ion-exchange treatment.

The ion-exchange treatment is preferably performed by a standard method, i.e., a method in which the organic template-containing zeolite is immersed in a solution, preferably an aqueous solution, containing ammonium ions and/or protons, and the mixture is stirred or fluidized. The stirring or fluidization is preferably performed under heating to increase the efficiency of ion-exchange. In the present embodiment, it is particularly preferable to use a method in which the above aqueous solution is heated, boiled, and ion-exchanged under reflux.

Furthermore, in terms of increasing the efficiency of ion-exchange, it is preferable, during the ion-exchange of the zeolite in a solution, to exchange the solution with a new one once or greater times, and it is more preferable to exchange the solution with a new one once or twice. When the solution is once exchanged, the ion-exchange efficiency can be increased by, for example, immersing the organic template-containing zeolite in a solution containing ammonium ions and/or protons, heating the solution under reflux for 1 to 6 hours, and then exchanging the solution with a new one, further followed by heating under reflux for 6 to 12 hours.

By the ion-exchange treatment, almost all of the counter cations, such as alkali metal, in the zeolite can be exchanged with ammonium ions and/or protons. On the other hand, although part of the organic template contained in the zeolite is removed by the ion-exchange treatment, it is generally difficult to remove the entire organic template even by repeating this treatment, and so part of the organic template remains in the zeolite.

In the present embodiment, a mixture containing the ion-exchanged zeolite and a binder is heated under a nitrogen atmosphere at a temperature of 250 to 350° C. to thereby obtain a support precursor.

The mixture containing the ion-exchanged zeolite and a binder is preferably formed by mixing the ion-exchanged zeolite obtained by the above method with an inorganic oxide, which serves as a binder, and molding the resulting composition. The purpose of mixing the ion-exchanged zeolite with an inorganic oxide is to improve the mechanical strength of the support (particularly particulate support) obtained by calcining the molded product to a degree that can withstand practical use; however, the present inventor found that the selection of the type of inorganic oxide affects the isomerization selectivity of the hydroisomerization catalyst. From such a viewpoint, the inorganic oxide used is at least one inorganic oxide selected from alumina, silica, titania, boria, zirconia, magnesia, ceria, zinc oxide, phosphorus oxide, and a composite oxide comprising a combination of two or greater of these oxides. Among these, silica and alumina are preferable, and alumina is more preferable, in terms of further improving the isomerization selectivity of the hydroisomerization catalyst. The “composite oxide comprising a combination of two or greater of these oxides” is a composite oxide comprising at least two components selected from alumina, silica, titania, boria, zirconia, magnesia, ceria, zinc oxide, and phosphorus oxide. An alumina-based composite oxide comprising 50 mass % or greater of alumina component based on the composite oxide is preferred; and particularly, alumina silica is more preferred.

The blending ratio of the ion-exchanged zeolite and the inorganic oxide in the above composition is preferably 10:90 to 90:10, and more preferably 30:70 to 85:15, in terms of the mass ratio of the ion-exchanged zeolite to the inorganic oxide. A mass ratio of less than 10:90 is not preferable because the activity of the hydroisomerization catalyst tends to be insufficient. In contrast, a mass ratio of more than 90:10 is not preferable because the mechanical strength of the support obtained by molding and calcining the composition tends to be insufficient.

The method for mixing the ion-exchanged zeolite with the above inorganic oxide is not particularly limited, and a standard method can be used. For example, a suitable amount of liquid (e.g., water) is added to powders of both components to form a viscous fluid, and the fluid is kneaded with a kneader or the like.

A composition containing the ion-exchanged zeolite and the inorganic oxide, or a viscous fluid containing the composition, is molded by extrusion molding or the like, and preferably dried to form a particulate molded product. The shape of the molded product is not particularly limited. For example, the molded product may have a cylindrical shape, a pellet shape, a spherical shape, or an irregular tubular shape having a three-leaf-shaped or four-leaf-shaped cross section. Although the size of the molded product is not particularly limited, the molded product preferably has, for example, a long axis of about 1 to 30 mm and a short axis of about 1 to 20 mm, in terms of ease of handling, load density into the reactor, and the like.

In the present embodiment, it is preferable to heat the molded product obtained in the above manner under an N₂ atmosphere at a temperature of 250 to 350° C. to form a support precursor. The heating time is preferably 0.5 to 10 hours, and more preferably 1 to 5 hours.

In the present embodiment, when the above heating temperature is lower than 250° C., a large amount of the organic template remains, and the zeolite micropores are clogged by the remaining template. Isomerization active sites are considered to exist in the vicinity of the micropore mouth. In the above case, the reaction substrate cannot be diffused into the micropores due to the clogging of the micropores, and the active sites are covered to hinder the progress of the isomerization reaction. As a result, sufficient conversion of normal paraffins tends not to be obtained. In contrast, when the heating temperature is higher than 350° C., the isomerization selectivity of the resulting hydroisomerization catalyst is not sufficiently improved.

When the molded product is heated to form a support precursor, the lower limit temperature is preferably 280° C. or greater, and the upper limit temperature is preferably 330° C. or less.

In the present embodiment, it is preferable to heat the above mixture so that part of the organic template contained in the molded product remains. Specifically, it is preferable to set the heating conditions so that the micropore volume per unit mass of the hydroisomerization catalyst obtained by calcination after metal supporting, described later, is 0.02 to 0.11 cm³/g, and so that the micropore volume per unit mass of the zeolite contained in the catalyst is 0.04 to 0.12 cm³/g.

Next, the catalyst precursor obtained by incorporating a platinum salt and/or a palladium salt into the above support precursor is calcined in an atmosphere containing molecular oxygen at a temperature of 350 to 400° C., preferably 380 to 400° C., and more preferably 400° C., thereby obtaining a hydroisomerization catalyst in which platinum and/or palladium is supported on the zeolite-containing support. Note that the phrase “in an atmosphere containing molecular oxygen” means that the catalyst precursor is brought into contact with gas containing oxygen gas, particularly preferably air. The calcination time is preferably 0.5 to 10 hours, and more preferably 1 to 5 hours.

Examples of the platinum salt include chloroplatinic acid, tetraammineplatinum dinitrate, dinitroaminoplatinum, tetraamminedichloroplatinum, and the like. If a chloride salt is used, hydrochloric acid may be generated during the reaction and cause apparatus corrosion; therefore, it is preferable to use tetraammineplatinum dinitrate, which is not a chloride salt, but a platinum salt in which platinum is highly dispersed.

Examples of the palladium salt include palladium chloride, tetraammine palladium nitrate, diaminopalladium nitrate, and the like. If a chloride salt is used, hydrochloric acid may be generated during the reaction to cause apparatus corrosion; therefore, it is preferable to use tetraammine palladium nitrate, which is not a chloride salt, but is a palladium salt in which palladium is highly dispersed.

The amount of the active metal supported on the zeolite-containing support according to the present embodiment is preferably 0.001 to 20 mass %, and more preferably 0.01 to 5 mass %, based on the mass of the support. When the amount of the metal supported is less than 0.001 mass %, it is difficult to impart the predetermined hydrogenation/dehydrogenation function. In contrast, when the amount of the metal supported is more than 20 mass %, lightening is more likely to proceed due to the cracking of hydrocarbons on the active metal, and the yield of the target fraction tends to decrease. Further, catalyst costs tend to increase. Thus, this amount is not preferred.

In the present embodiment, it is preferable to calcine the above catalyst precursor so that the organic template remaining in the above support precursor still remains. Specifically, it is preferable to set the heating conditions so that the micropore volume per unit mass of the hydroisomerization catalyst to be obtained is 0.02 to 0.11 cm³/g, and so that the micropore volume per unit mass of the zeolite contained in the catalyst is 0.04 to 0.12 cm³/g.

The micropore volume per unit mass of the hydroisomerization catalyst is calculated by a method called nitrogen adsorption measurement. That is, the micropore volume per unit mass of the catalyst is calculated by analyzing the nitrogen physical adsorption-desorption isotherm of the catalyst measured at a liquid nitrogen temperature (−196° C.), specifically analyzing the nitrogen adsorption isotherm measured at a liquid nitrogen temperature (−196° C.) by the t-plot method. Further, the micropore volume per unit mass of the zeolite contained in the catalyst is also calculated by the above nitrogen adsorption measurement.

Note that the micropores as mentioned in the present specification refer to “pores having a diameter of 2 nm or less” as defined by the International Union of Pure and Applied Chemistry (IUPAC).

For example, when the binder does not have a micropore volume, the micropore volume V_{Z} per unit mass of the zeolite contained in the catalyst can be calculated from the micropore volume V_{c} per unit mass of the hydroisomerization catalyst and the content ratio M_{Z} (mass %) of the zeolite in the catalyst according to the following formula:

V_{Z}=V_{c}/M_{z}×100

Following the above calcination treatment, the hydroisomerization catalyst of the present embodiment is preferably subjected to reduction treatment after the catalyst is placed in a reactor for carrying out a hydroisomerization reaction. Specifically, it is preferable that the hydroisomerization catalyst of the present embodiment is subjected to reduction treatment in an atmosphere containing molecular hydrogen, and preferably in a hydrogen gas flow, preferably at 250 to 500° C., and more preferably at 300 to 400° C., for about 0.5 to 5 hours. This process can reliably impart high activity for the dewaxing of hydrocarbon oil to the catalyst.

The hydroisomerization catalyst of the present embodiment comprises a support containing a zeolite having a 10-membered ring one-dimensional pore structure and a binder, and platinum and/or palladium supported on the support, wherein the micropore volume per unit mass of the catalyst is 0.02 to 0.11 cm³/g. The above zeolite is derived from an ion-exchanged zeolite obtained by ion-exchange of an organic template-containing zeolite that contains an organic template and has a 10-membered ring one-dimensional pore structure, in a solution containing ammonium ions and/or protons. The micropore volume per unit mass of the zeolite contained in the catalyst may be 0.04 to 0.12 cm³/g.

The hydroisomerization catalyst can be produced by the above-mentioned method. The micropore volume per unit mass of the catalyst and the micropore volume per unit mass of the zeolite contained in the catalyst can be set within the above ranges by appropriately adjusting the amount of the ion-exchanged zeolite in the mixture containing the ion-exchanged zeolite and a binder, the conditions for heating the mixture under N₂ atmosphere, and the conditions for heating the catalyst precursor in an atmosphere containing molecular oxygen. The reaction temperature of hydroisomerization dewaxing in the second step is preferably 200 to 450° C., and more preferably 220 to 400° C. When the reaction temperature is lower than 200° C., the isomerization of normal paraffins contained in the base oil fraction is less likely to proceed, and the reduction and removal of the wax component tend to be insufficient. In contrast, when the reaction temperature is higher than 450° C., the cracking of the base oil fraction becomes significant, and the yield of the lubricating base oil tends to decrease.

Moreover, the reaction pressure of hydroisomerization dewaxing is preferably 0.1 to 20 MPa, and more preferably 0.5 to 15 MPa. When the reaction pressure is lower than 0.1 MPa, the degradation of the catalyst due to coke formation tends to be accelerated. In contrast, when the reaction pressure is higher than 20 MPa, apparatus construction costs tend to increase, making it difficult to achieve an economically viable process.

In the second step, the liquid-hourly space velocity of the processed oil (hydrocracked oil) relative to the catalyst is preferably 0.01 to 100 hr⁻¹, and more preferably 0.1 to 50 hr⁻¹. When the liquid-hourly space velocity is less than 0.01 hr⁻¹, the cracking of the base oil fraction is likely to progress excessively, and productive efficiency tends to be reduced. In contrast, when the liquid-hourly space velocity is more than 100 hr⁻¹, the isomerization of normal paraffins contained in the base oil fraction is less likely to proceed, and the reduction and removal of the wax component tend to be insufficient.

The feed ratio of hydrogen and processed oil (hydrocracked oil) is preferably 100 to 1,000 Nm³/m³, and more preferably 200 to 800 Nm³/m³. At a feed ratio of less than 100 Nm³/m³, when the base oil fraction contains sulfur components or nitrogen components, for example, hydrogen sulfide and ammonia gas generated by desulfurization and denitrification reaction occurring concurrently with the isomerization reaction cause adsorption poisoning of the active metal on the catalyst Thus, the desired catalytic performance tends to be difficult to achieve. In contrast, when the feed ratio is more than 1,000 Nm³/m³, hydrogen supply equipment with large capacity tends to be required, making it difficult to achieve an economically viable process.

The dewaxed oil obtained by the second step may be subjected to a hydrofinishing step, if necessary.

The reactor used in the hydrofinishing step is not particularly limited. The hydrofinishing treatment (hydrorefining treatment) can be suitably performed by placing a predetermined hydrorefining catalyst in a fixed-bed flow reactor, and passing molecular hydrogen and the above dewaxed oil through the reactor. The hydrofinishing treatment (hydrorefining treatment) as mentioned herein is intended to improve the oxidation stability and hue of the lubricating oil. The dewaxed oil is subjected to olefin hydrogenation or aromatic hydrogenation.

Examples of the hydrorefining catalyst include catalysts comprising a support containing one or greater inorganic solid acidic substances selected from alumina, silica, zirconia, titania, boria, magnesia, and phosphorus; and one or greater active metals selected from the group consisting of platinum, palladium, nickel-molybdenum, nickel-tungsten, and nickel-cobalt-molybdenum, supported on the support.

A preferred support is an inorganic solid acidic substance containing at least two members selected from alumina, silica, zirconia, and titania.

The method for supporting the above active metal on the support may be a standard method, such as impregnation or ion-exchange.

The amount of the active metal supported in the hydrorefining catalyst is preferably such that the total metal amount is 0.1 to 25 mass %, based on the support.

The average pore diameter of the hydrorefining catalyst is preferably 6 to 60 nm, and more preferably 7 to 30 nm. When the average pore diameter is less than 6 nm, sufficient catalytic activity tends not to be obtained. When the average pore diameter is more than 60 nm, the dispersibility of the active metal tends to decrease to thereby reduce the catalytic activity. Moreover, the pore volume of the hydrorefining catalyst is preferably 0.2 mL/g or greater. When the pore volume is less than 0.2 mug, the degradation of the catalyst activity tends to be accelerated. Furthermore, the specific surface area of the hydrorefining catalyst is preferably 200 m²/g or greater. When the specific surface area of the catalyst is less than 200 m²/g, the dispersibility of the active metal is insufficient, and the activity tends to be reduced. The pore volume and specific surface area of the catalyst can be measured and calculated by a method called the BET method using nitrogen adsorption.

The reaction conditions in the hydrofinishing step are preferably such that the reaction temperature is 200 to 300° C., the hydrogen partial pressure is 3 to 20 MPa, the LHSV is 0.5 to 5 h⁻¹, and the hydrogen/oil ratio is 1,000 to 5,000 scfb; and more preferably such that the reaction temperature is 200° C. to 300° C., the hydrogen partial pressure is 4 to 18 MPa, the LHSV is 0.5 to 4 h⁻¹, and the hydrogen/oil ratio is 2,000 to 5,000 scfb.

In the present embodiment, the reaction conditions are preferably adjusted so that the sulfur content and nitrogen content in the hydrorefined oil are 5 mass ppm or less and 1 mass ppm or less, respectively.

Moreover, the dewaxed base oil obtained by the second step, or the refined oil obtained by the hydrofinishing step, may be further subjected to a fractionation step. In the fractionation step, a plurality of cut points is set, and the hydrorefined oil is subjected to vacuum distillation, thereby obtaining a desired lubricating oil fraction.

The hydrorefined oil may contain naphtha, kerosene light oil, and other light fractions produced as by-products of the hydroisomerization and hydrofinishing treatment (hydrorefining treatment); however, these light fractions can be collected as, for example, fractions having a boiling point of 350° C. or less.

The method for producing a lubricating base oil according to the present invention is not limited to the above-mentioned embodiment, and can be suitably changed. For example, the method for producing a lubricating base oil according to the present invention may comprise a distillation step of fractionating the dewaxed oil obtained by the above method to obtain a lubricating oil fraction, and a hydrofinishing step of hydrofinishing (hydrorefining) the lubricating oil fraction obtained by the distillation step.

The lubricating base oil according to the present embodiment can be preferably used for various lubricating base oil applications. Specific applications of the lubricating base oil according to the present embodiment include lubricating oils for internal combustion engines, such as automobile gasoline engines, motorcycle gasoline engines, diesel engines, gas engines, gas heat pump engines, marine engines, and power-generation engines (internal combustion engine oils); lubricating oils for drive transmissions, such as automatic transmissions, manual transmissions, continuously variable transmissions, and final reduction gears (drive transmission oils); hydraulic oils for hydraulic power units, such as dampers and construction machines; compressor oils, turbine oils, industrial gear oils, refrigerant oils, rust preventive oils, heat medium oils, gasholder seal oils, bearing oils, paper machine oils, machine tool oils, slide guiding surface oils, electrically insulating oils, cutting oils, press oils, rolling oils, quenching oils, and the like. Among these applications, when the lubricating base oil according to the present embodiment is used for electrically insulating oils and other applications for which electrical insulating properties are required, higher electrical insulating properties can be achieved, compared with conventional electrically insulating oils.

For the above applications, the lubricating base oil according to the present embodiment may be used alone; alternatively, the lubricating base oil according to the present embodiment may be used in combination with one or greater other base oils. When the lubricating base oil according to the present embodiment is used in combination with other base oil(s), the ratio of the lubricating base oil according to the present embodiment in the base oil mixture is preferably 30 mass % or greater, more preferably 50 mass % or greater, and even more preferably 70 mass % or greater.

Other base oils used in combination with the lubricating base oil according to the present embodiment are not particularly limited. Examples of mineral oil base oils include solvent-refined mineral oils, hydrocracked mineral oils, hydrorefined mineral oils, solvent-dewaxed base oils, and other mineral oil base oils having a kinematic viscosity at 100° C. of 1 to 100 mm²/s.

Moreover, examples of synthetic base oils include poly-α-olefins or hydrides thereof, isobutene oligomers or hydrides thereof, isoparaffins, alkylbenzenes, alkylnaphthalenes, diesters (ditridecyl glutarate, di-2-ethylhexyl adipate, diisodecyl adipate, ditridecyl adipate, di-2-ethylhexyl sebacate, and the like), polyol esters (trimethylolpropane caprylate, trimethylolpropane pelargonate, pentaerythritol 2-ethylhexanoate, pentaerythritol pelargonate, and the like), polyoxyalkylene glycols, dialkyl diphenyl ethers, polyphenyl ethers, and the like. Among these, poly-α-olefins are preferable. Typical examples of poly-α-olefins include oligomers or co-oligomers of α-olefins having 2 to 32, preferably 6 to 16, carbon atoms (1-octene oligomer, decene oligomer, ethylene-propylene co-oligomer, and the like), and hydrides thereof.

Although the method for producing poly-α-olefins is not particularly limited, as an example an ca-olefin is polymerized in the presence of a polymerization catalyst, such as a Friedel-Crafts catalyst containing a complex of aluminum trichloride or boron trifluoride; and water, an alcohol (ethanol, propanol, butanol, and the like), and a carboxylic acid or an ester.

Further, if necessary, various additives can be added to the lubricating base oil according to the present embodiment, or to a base oil mixture of the lubricating base oil and other lubricating base oil(s). Such additives are not particularly limited, and any additives that are conventionally used in the field of lubricating oils can be added. Specific examples of such lubricating oil additives include antioxidants, ashless dispersants, metal-based detergents, extreme-pressure agents, anti-wear agents, viscosity index improvers, pour-point depressants, friction modifiers, oily agents, corrosion inhibitors, anti-rust agents, demulsifiers, metal deactivators, seal swelling agents, antifoaming agents, coloring agents, and the like. These additives may be used singly or in combination of two or greater.

Further, if necessary, various additives can be added to the lubricating base oil according to the present embodiment, or to a base oil mixture of the lubricating base oil and other lubricating base oil(s). Such additives are not particularly limited, and any additives that are conventionally used in the field of lubricating oils can be added. Specific examples of such lubricating oil additives include antioxidants, ashless dispersants, metal-based detergents, extreme-pressure agents, anti-wear agents, viscosity index improvers, pour-point depressants, friction modifiers, oily agents, corrosion inhibitors, anti-rust agents, demulsifiers, metal deactivators, seal swelling agents, antifoaming agents, coloring agents, and the like. These additives may be used singly or in combination of two or greater.

### EXAMPLES

The present invention is described in more detail below based on Examples and Comparative Examples; however, the present invention is not limited to the following Examples.

### Production Example 1

### Preparation of Hydroisomerization Catalyst A-1

### <Production of ZSM-22 Zeolite>

A ZSM-22 zeolite containing an organic template, having a molar ratio of silica/alumina of 45, and comprising a crystalline aluminosilicate was synthesized by the following procedures. Hereinafter, the ZSM-22 zeolite is referred to as “ZSM-22.”

First, the following four aqueous solutions were prepared.

Solution A: a solution prepared by dissolving 1.94 g of potassium hydroxide in 6.75 mL of ion-exchanged water.

Solution B: a solution prepared by dissolving 1.33 g of aluminum sulfate 18-hydrate in 5 mL of ion-exchanged water.

Solution C: a solution prepared by diluting 4.18 g of 1,6-hexanediamine (organic template) with 32.5 mL of ion-exchanged water.

Solution D: a solution prepared by diluting 18 g of colloidal silica (Ludox AS-40, produced by Grace Davison) with 31 mL of ion-exchanged water.

Next, the solution A was added to the solution B, and the mixture was stirred until the aluminum component was completely dissolved. After the solution C was added to the mixed solution, while vigorously stirring at room temperature, the mixture of the solutions A, B, and C was poured into the solution D. Further, to the resulting mixture, 0.25 g of ZSM-22 powder, which had been separately synthesized and had not been subjected to any special treatment after the synthesis, was added as a “seed crystal” for promoting crystallization, thereby obtaining a gelled product.

The gelled product obtained by the above operation was transferred to a stainless steel-autoclave reactor with an inner volume of 120 mL, and the autoclave reactor was rotated on a tumbling device at a rotational speed of about 60 rpm for 60 hours in an oven at 150° C. to perform a hydrothermal synthesis reaction. After completion of the reaction, the reactor was cooled and then opened, followed by drying in a dryer at 60° C. overnight, thereby obtaining ZSM-22 having a Si/Al ratio of 45.

### <Ion-Exchange of Organic Template-Containing ZSM-22>

The ZSM-22 obtained above was subjected to ion-exchange treatment in an aqueous solution containing ammonium ions by the following operation.

The ZSM-22 obtained above was taken in a flask, a 0.5 N-ammonium chloride aqueous solution in an amount of 100 mL per gram of the ZSM-22 zeolite was added thereto, and the mixture was heated under reflux for 6 hours. After the mixture was cooled to room temperature, the supernatant was removed, and the crystalline aluminosilicate was washed with ion-exchanged water. To the resulting product, the same amount of 0.5 N-ammonium chloride aqueous solution as above was added again, and the mixture was heated under reflux for 12 hours.

Thereafter, the solid was collected by filtration, washed with ion-exchanged water, and dried in a dryer at 60° C. overnight, thereby obtaining an ion-exchanged NH₄-type ZSM-22. This ZSM-22 was ion-exchanged in a state containing an organic template.

### <Mixing of Binder, Molding, and Calcination>

The NH₄-type ZSM-22 obtained above and alumina, which served as a binder, were mixed at a mass ratio of 7:3. A small amount of ion-exchanged water was added thereto, and the mixture was kneaded. The resulting viscous fluid was placed in an extruder and molded into a cylindrical molded product having a diameter of about 1.6 mm and a length of about 10 mm. The molded product was heated under N₂ atmosphere at 300° C. for 3 hours, thereby obtaining a support precursor.

### <Platinum Supporting and Calcination>

Tetraammineplatinum dinitrate [Pt(NH₃)₄](NO₃)₂ was dissolved in ion-exchanged water in an amount corresponding to the amount of water absorption of the support precursor that had been previously measured, thereby obtaining an impregnation solution. This solution was impregnated in the above support precursor by an incipient impregnation method, and supporting was performed so that the amount of platinum was 0.3 mass % based on the mass of the ZSM-22 type zeolite. Next, the resulting impregnated product (catalyst precursor) was dried in a dryer at 60° C. overnight, and then calcined in an air flow at 400° C. for 3 hours, thereby obtaining a hydroisomerization catalyst A-1.

Further, the micropore volume per unit mass of the obtained hydroisomerization catalyst was calculated in the following manner. First, in order to remove moisture adsorbed in the hydroisomerization catalyst, pretreatment for evacuation was performed at 150° C. for 0.5 hours. The pretreated hydroisomerization catalyst was subjected to nitrogen adsorption measurement using a BELSORP-max (produced by BEL Japan, Inc.) at a liquid nitrogen temperature (−196° C.). Then, the measured nitrogen adsorption isotherm was analyzed by the t-plot method, and the micropore volume per unit mass of the hydroisomerization catalyst (cm³/g) was calculated. The result was 0.055.

Furthermore, when the micropore volume V_{Z} per unit mass of the zeolite contained in the catalyst was calculated according to the following formula, the result was 0.079. In addition, when the alumina used as a binder was subjected to nitrogen adsorption measurement in the same manner as described above, it was confirmed that the alumina had no micropores.

V_{Z}=V_{c}/M_{z}×100

wherein V_{c} indicates the micropore volume per unit mass of the hydroisomerization catalyst, and M_{z} indicates the content ratio (mass %) of the zeolite contained in the catalyst.

### Example 1

GTL wax containing 33 wt. % of normal paraffin of 350 to 420° C. boiling-range fraction was hydroisomerized under the following conditions: isomerization reaction temperature: 320° C.; hydrogen pressure: 15 MPa; hydrogen/oil ratio: 500 NL/L; and liquid-hourly space velocity: 1.5 h⁻¹. The hydroisomerization catalyst used was the hydroisomerization catalyst A-1 mentioned above. Note that the reaction temperature is a temperature that provides substantially 100% conversion. In the produced oil, the content of the main target fraction, i.e., fraction having a boiling range of 370 to 410° C., was 60 volume %.

The produced oil obtained in this manner was fractionated to obtain base oils corresponding to three viscosity grades, 70 Pale, SA 10, and SAE 20.

### Example 2

GTL wax containing 47 wt. % of normal paraffin of 350 to 420° C. boiling-range fraction was hydroisomerized under the following conditions: isomerization reaction temperature: 320° C.; hydrogen pressure: 15 MPa; hydrogen/oil ratio: 500 NL/L; and liquid-hourly space velocity: 1.5 h⁻¹. The hydroisomerization catalyst used was the hydroisomerization catalyst A-1 mentioned above. Note that the reaction temperature is a temperature that provides substantially 100% conversion. In the produced oil, the content of the main target fraction, i.e., fraction having a boiling range of 370 to 410° C., was 55 volume %.

The produced oil obtained in this manner was fractionated to obtain base oils corresponding to three viscosity grades, 70 Pale, SA 10, and SAE 20.

### Comparative Example 1

As conventional lubricating base oils produced by using a synthetic wax obtained by a gas-to-liquid process as a raw material, base oils corresponding to three viscosity grades, 70 Pale, SA 10, and SAE 20, were prepared (Spectrasyn 2, produced by ExxonMobil).

### Comparative Example 2

GTL wax containing 26 wt. % of normal paraffin of 350 to 420° C. boiling-range fraction was hydroisomerized under the following conditions: isomerization reaction temperature: 300° C.; hydrogen pressure: 15 MPa; hydrogen/oil ratio: 500 NL/L; and liquid-hourly space velocity: 1.5 h⁻¹. The hydroisomerization catalyst used was the hydroisomerization catalyst A-1 mentioned above. Note that the reaction temperature is a temperature that provides substantially 100% conversion. In the produced oil, the content of the main target fraction, i.e., fraction having a boiling range of 370 to 410° C., was 70 volume %.

The produced oil obtained in this manner was fractionated to obtain base oils corresponding to three viscosity grades, 70 Pale, SA 10, and SAE 20.

### Comparative Example 3

GTL wax containing 55 wt. % of normal paraffin of 350 to 420° C. boiling-range fraction was hydroisomerized under the following conditions: isomerization reaction temperature: 340° C.; hydrogen pressure: 15 MPa; hydrogen/oil ratio: 500 NL; and liquid-hourly space velocity: 1.5 h⁻¹. The hydroisomerization catalyst used was the hydroisomerization catalyst A-1 mentioned above. Note that the reaction temperature is a temperature that provides substantially 100% conversion. In the produced oil, the content of the main target fraction, i.e., fraction having a boiling range of 370 to 410° C., was 45 volume %.

The produced oil obtained in this manner was fractionated to obtain base oils corresponding to three viscosity grades, 70 Pale, SA 10, and SAE 20.

### Comparative Example 4

As commercially available group II base oils, base oils corresponding to three viscosity grades, 70 Pale, SA 10, and SAE 20, were prepared.

Table 1 shows the various properties of the base oils of Examples 1 and 2, and Comparative Examples 1 to 4. Note that in the “type of base oil” column in Table 1, “PAO” refers to a poly-α-olefin; “GTL” refers to a lubricating base oil produced by using, as a raw material, a synthetic wax obtained by a gas-to-liquid process, or a lubricating oil fraction separated from the synthetic wax; and “GpII” refers to a group II base oil. Moreover, the “content ratio of normal paraffins” is the content ratio of normal paraffins in the hydrocracked oil (the oil to be subjected to the second step) obtained by the first step.

TABLE 1

| | Comp. | Comp. | | | Comp. | Comp. |
|---|---|---|---|---|---|---|
| | Ex. 1 | Ex. 2 | Ex. 1 | Ex. 2 | Ex. 3 | Ex 4 |
| Type of base oil | PAO | GTL | GTL | GTL | GTL | GpII |
| Content ratio of normal paraffins, mass % | — | 26 | 33 | 47 | 55 | — |
| 70 Pale | | | | | | |
| Density | 0.7983 | 0.8077 | 0.8077 | 0.8077 | 0.8070 | 0.8332 |
| Kinematic viscosity (40° C.), mm²/s | 5.195 | 9.078 | 9.078 | 9.078 | 8.996 | 13.46 |
| Kinematic viscosity (100° C.), mm²/s | 1.722 | 2.601 | 2.601 | 2.601 | 2.580 | 3.273 |
| Viscosity index | 93 | 123 | 123 | 123 | 120 | 112 |
| Pour point, ° C. | <−45 | −40 | −35 | −40 | <−45 | −22.5 |
| Sulfur content, mass ppm | <10 | <10 | <10 | <10 | <10 | <10 |
| Nitrogen content, mass ppm | <10 | <10 | <10 | <10 | <10 | <10 |
| Surface tension (25° C.), mN/m | 27.5 | 27.1 | 27.9 | 27.5 | 26.8 | 24.8 |
| Surface tension (80° C.), mN/m | 24.8 | 25.0 | 25.2 | 25.0 | 24.3 | 24.1 |
| Dielectric breakdown voltage, kV | 50 | 53 | 63 | 61 | 45 | 38 |
| Volume resistivity (25° C.), TΩ · m | 47 | 125 | 270 | 167 | 98 | 24 |
| Volume resistivity (80° C.), TΩ · m | 39 | 85 | 103 | 98 | 69 | 18 |
| B(25° C.)/A(80° C.) | 1.21 | 1.47 | 2.62 | 1.70 | 1.42 | 1.33 |
| CCS viscosity (−35° C.), mPa · s | 1010 | 1380 | 980 | 880 | 780 | 1600 |
| SAE 10 | | | | | | |
| Density | 0.8199 | 0.8180 | 0.8180 | 0.8180 | 0.8189 | 0.8347 |
| Kinematic viscosity (40° C.), mm²/s | 18.17 | 15.78 | 15.78 | 15.78 | 17.89 | 19.97 |
| Kinematic viscosity (100° C.), mm²/s | 4.064 | 3.862 | 3.862 | 3.862 | 1.113 | 4.290 |
| Viscosity index | 125 | 142 | 142 | 142 | 134 | 123 |
| Pour point, ° C. | <−45 | −17.5 | −20 | −30 | −40 | −17.5 |
| Sulfur content, mass ppm | <10 | <10 | <10 | <10 | <10 | <10 |
| Nitrogen content, mass ppm | <10 | <10 | <10 | <10 | <10 | <10 |
| Surface tension (25° C.), mN/m | 27.6 | 28.9 | 29.7 | 29.3 | 28 | 27.5 |
| Surface tension (80° C.), mN/m | 25.4 | 25.1 | 25.7 | 25.4 | 24.9 | 24.6 |
| Dielectric breakdown voltage, kV | 54 | 59 | 65 | 63 | 55 | 48 |
| Volume resistivity (25° C.), TΩ · m | 51 | 152 | 300 | 180 | 105 | 34 |
| Volume resistivity (80° C.), TΩ · m | 43 | 110 | 119 | 106 | 82 | 21 |
| B(25° C.)/A(80° C.) | 1.19 | 1.39 | 2.52 | 1.70 | 1.28 | 1.42 |
| CCS viscosity (−35° C.), mPa · s | 1400 | 1950 | 1650 | 1400 | 1280 | 2100 |
| SAE 20 | | | | | | |
| Density | 0.8236 | 0.8258 | 0.8258 | 0.8258 | 0.8278 | 0.8399 |
| Kinematic viscosity (40° C.), mm²/s | 29.89 | 32.88 | 32.88 | 32.88 | 30.81 | 34.63 |
| Kinematic viscosity (100° C.), mm²/s | 5.724 | 6.588 | 6.588 | 6.588 | 6.071 | 6.303 |
| Viscosity index | 136 | 160 | 160 | 160 | 146 | 134 |
| Pour point, ° C. | <−45 | −12.5 | −15 | −25 | −30 | −12.5 |
| Sulfur content, mass ppm | <10 | <10 | <10 | <10 | <10 | <10 |
| Nitrogen content, mass ppm | <10 | <10 | <10 | <10 | <10 | <10 |
| Surface tension (25° C.), mN/m | 30.2 | 30.3 | 31.5 | 31.1 | 29.2 | 28.2 |
| Surface tension (80° C.), mN/m | 26.3 | 26.4 | 26.7 | 26.3 | 26.1 | 24.9 |
| Dielectric breakdown voltage, kV | 58 | 59 | 68 | 63 | 55 | 51 |
| Volume resistivity (25° C.), TΩ · m | 53 | 178 | 335 | 196 | 128 | 33 |
| Volume resistivity (80° C.), TΩ · m | 45 | 120 | 128 | 115 | 89 | 23 |
| B(25° C.)/A(80° C.) | 1.18 | 1.48 | 2.62 | 1.70 | 1.44 | 1.43 |
| CCS viscosity (−35° C.), mPa · s | 1640 | 1780 | 1320 | 1210 | 980 | 2400 |

1. A method for producing a lubricating base oil, the method comprising:
a first step of subjecting a synthetic wax obtained by a gas-to-liquid process, or a lubricating fraction separated from the synthetic wax, to hydrocracking, thereby obtaining a hydrocracked oil having a normal paraffin content of 30% or greater and 50% or less; and
a second step of subjecting the hydrocracked oil to hydroisomerization dewaxing in the presence of a hydroisomerization catalyst, thereby obtaining a lubricating base oil;
wherein the lubricating base oil has a volume resistivity at 80° C. of 1 TΩ·m or greater, and
a volume resistivity at 25° C. relative to the volume resistivity at 80° C. that satisfies conditions represented by the following formula (1):
B(25° C.)/A(80° C.)≧1.5 (1)
wherein in formula (1), A (80° C.) indicates the volume resistivity at 80° C. of the lubricating base oil, and B (25° C.) indicates the volume resistivity at 25° C. of the lubricating base oil.

2. The method for producing a lubricating base oil according to claim 1, wherein the hydroisomerization catalyst comprises:
at least one crystalline solid acidic substance selected from the group consisting of ZSM-22 type zeolite, ZSM-23 type zeolite, SSZ32, and ZSM-48 type zeolite; and
platinum and/or palladium as an active metal.

3. A lubricating base oil obtained by the production method according to claim 1, wherein the volume resistivity at 80° C. is 1 TΩ·m or greater, and the volume resistivity at 25° C. relative to the volume resistivity at 80° C. satisfies conditions represented by the following formula (1):
B(25° C.)/A(80° C.)≧1.5 (1)
wherein in formula (1), A (80° C.) indicates the volume resistivity at 80° C. of the lubricating base oil, and B (25° C.) indicates the volume resistivity at 25° C. of the lubricating base oil.

4. An electrically insulating oil comprising the lubricating base oil according to claim 3.

5. The method according to claim 1, wherein the lubricating base oil has a volume resistivity at 80° C. of 70 TΩ·m or greater.

6. The lubricating base oil according to claim 3, wherein the volume resistivity at 80° C. is 70 TΩ·m or greater.
